(19) United States
(12) Patent Application Publication
(10) Pub. No.: US 2014/0126459 A1
(43) Pub. Date: May 8, 2014

(54) METHOD AND APPARATUS FOR TRANSMITTING BROADCASTING MESSAGE IN WIRELESS ACCESS SYSTEM SUPPORTING M2M ENVIRONMENT

(71) Applicants: Jeongki Kim, Anyang-si (KR); Youngsoo Yuk, Anyang-si (KR)

(72) Inventors: Jeongki Kim, Anyang-si (KR); Youngsoo Yuk, Anyang-si (KR)

(73) Assignee: LG ELECTRONICS INC., Seoul (KR)

(21) Appl. No.: 14/129,030

(22) PCT Filed: Jun. 22, 2012
(86) PCT No.: PCT/KR2012/004960

§ 371 Date: Dec. 23, 2013

Related U.S. Application Data
(60) Provisional application No. 61/500,143, filed on Jun. 23, 2011.
(60) Provisional application No. 61/504,231, filed on Jul. 3, 2011.
(60) Provisional application No. 61/568,164, filed on Dec. 8, 2011.
(60) Provisional application No. 61/585,661, filed on Jan. 12, 2012.

(51) Int. Cl. H04W 72/00; H04W 4/00

(52) U.S. Cl. CPC H04W 72/005; H04W 4/005
USPC 370/312

(57) ABSTRACT

The present invention relates to a wireless access system supporting an M2M environment, and provides a method and an apparatus for broadcasting a medium access control (MAC) control message. A method for receiving a broadcasting message from the wireless access system supporting the M2M environment, according to one embodiment of the present invention, comprises the steps of: an M2M equipment receiving a broadcast allocation map information element including a message type field, which shows the type of the broadcasting message, and resource allocation information, which shows an allocation region of a broadcasting burst from which the broadcasting message is transmitted; and the M2M equipment confirming the type of the broadcasting message which is shown by the message type field, wherein when the broadcasting message type is related to the M2M equipment, the M2M equipment receives the broadcasting message through the broadcasting burst that is indicated by the resource allocation information, and when the broadcasting message type is not related to the M2M equipment, the M2M equipment does not decode the broadcasting burst that is indicated by the resource allocation information.

### TECHNICAL FIELD

The present invention relates to a wireless communication system supporting a machine-to-machine (M2M) environment and, more particularly, to various methods and apparatuses for transmitting a broadcast message.

### BACKGROUND ART

Hereinafter, a machine-to-machine communication environment in the present invention will be described in brief.

Machine-to-machine (M2M) communication refers to communication between electronic devices as the name implies. In a broad sense, M2M communication means wired or wireless communication between electronic devices or communication between a device controlled by humans and a machine. Recently, M2M communication generally refers to wireless communication between electronic devices without human intervention.

In the early 1990s when the concept of M2M communication was first introduced, M2M communication was recognized as remote control or telematics and the market therefor was very limited. However, M2M communication has rapidly advanced in the past few years and the market therefor has vastly expanded, attracting worldwide attention. In particular, M2M communication has exerted a significant influence on the fields of fleet management in a point-of-sale (POS) system and security-related application markets, remote monitoring of machines and facilities, and smart metering of measuring operating time of construction equipment and automatically measuring heat or electricity use. Future M2M communication will be extended to various applications in association with existing mobile communication, ultra-fast wireless Internet, or low-output communication solutions such as Wi-Fi and ZigBee. That is, M2M communication will be extended to business-to-consumer (B2C) markets beyond business-to-business (B2B) markets.

In an era of M2M communication, all machines equipped with a subscriber identity module (SIM) card are able to transmit and receive data so that they can be remotely managed and controlled. For example, M2M communication technology may be used in a wide range of devices and equipment such as automobiles, trucks, trains, shipping containers, vending machines, gas tankers, etc.

Conventionally, terminals were managed individually for one-to-one communication between a base station (BS) and a terminal Assuming that numerous M2M devices communicate with the BS through one-to-one communication, network overload is likely to occur due to signaling generated between each of the M2M devices and the BS. As M2M communication rapidly spreads and expands, overhead may be problematic due to communication between M2M devices or between M2M devices and a BS.

As M2M devices are frequently used, an environment in which normal terminals and the M2M devices are mixed is configured. Accordingly, when a conventional communication method is used, problems arise in that the normal terminals should decode all messages for the M2M devices.

For example, broadcast data or multicast data is a message transmitted from the BS in one-to-many correspondence. If the broadcast data or multicast data is transmitted to the M2M devices or normal terminals without distinction, the normal terminals and the M2M devices should decode all the transmitted broadcast data and thus power consumption may be abruptly increased. Furthermore, data which is supposed to be received by the normal terminals and the M2M devices may not be correctly received.

In addition, since medium access control (MAC) control messages transmitted to the M2M devices are transmitted in a broadcast form, if the MAC control messages (e.g. MOB-MTE-IND and MGMC) are not messages for an M2M group to which the M2M devices belong, the M2M devices should perform a process of decoding a burst for an MOB-MTE-IND message, confirming M2M CID included in the MAC control message, and determining whether the messages are for the M2M group to which the M2M devices belong.

In this case, if MAC control messages include only information about only one M2M group when the BS transmits the messages, there is a problem in that other M2M devices which do not belong the M2M group and normal terminals should receive unnecessary MAC control messages.

### DETAILED DESCRIPTION OF THE INVENTION

### Technical Problems

The present invention is devised to solve the afore-mentioned problems and an object of the present invention lies in providing an efficient communication method for M2M devices.

Another object of the present invention lies in providing methods for efficiently transmitting a broadcast message to M2M devices.

Still another object of the present invention lies in providing methods for selectively decoding broadcast bursts by M2M devices.

It will be appreciated by persons skilled in the art that the objects that could be achieved with the present invention are not limited to what has been particularly described hereinabove and the above and other objects that the present invention could achieve will be more clearly understood from the following detailed description.

### Technical Solutions

To achieve the above technical objects, the present invention relates to a wireless access system supporting an M2M environment and provides a method and apparatus for broadcasting a MAC control message.

According to an aspect of the present invention, provided herein is a method for receiving a broadcast message by an M2M device in a wireless access system supporting an M2M environment, including receiving a broadcast assignment MAP information element including a message type field indicating a type of the broadcast message and a resource assignment information indicating an assignment region of a broadcast burst through which the broadcast message is transmitted, and confirming the type of the broadcast message indicated by the message type field. The M2M device may receive the broadcast message through the broadcast burst indicated by the resource assignment information, when the type of the broadcast message is associated with the M2M device, and the M2M device may not decode the broadcast burst indicated by the resource assignment information, when the type of the broadcast message is not associated with the M2M device.

In another aspect of the present invention, provided herein is an M2M device for receiving a broadcast message in a wireless access system supporting an M2M environment, including a reception module and a processor for supporting reception of the broadcast message. The M2M device may receive, using the reception module, a broadcast assignment MAP information element including a message type field indicating a type of the broadcast message and a resource assignment information indicating an assignment region of a broadcast burst through which the broadcast message is transmitted and confirm, using the processor, the type of the broadcast message indicated by the message type field. The M2M device may receive the broadcast message through the broadcast burst indicated by the resource assignment information, when the type of the broadcast message is associated with the M2M device, and the M2M device may not decode the broadcast burst indicated by the resource assignment information, when the type of the broadcast message is not associated with the M2M device.

In still another aspect of the present invention, provided herein is a method for broadcasting a broadcast message by a base station in a wireless access system supporting an M2M environment, including broadcasting a broadcast assignment MAP information element including a message type field indicating a type of the broadcast message and a resource assignment information indicating an assignment region of a broadcast burst through which the broadcast message is transmitted, and broadcasting the broadcast message through the broadcast burst indicated by the resource assignment information.

In another aspect of the present invention, provided herein is a base station for broadcasting a broadcast message in a wireless access system supporting an M2M environment, including a transmission module and a processor for supporting broadcast of the broadcast message. The base station may broadcast, using the transmission module, a broadcast assignment MAP information element including a message type field indicating a type of the broadcast message and a resource assignment information indicating an assignment region of a broadcast burst through which the broadcast message is transmitted, and broadcast, using the transmission module, the broadcast message through the broadcast burst indicated by the resource assignment information.

In the aspects of the present invention, the message type field may indicate the type of the broadcast message in an index format or a bitmap format.

The broadcast assignment MAP information element may further include a mode indicator indicating whether the message type field is the index format or the bitmap format.

The M2M device may be an idle mode state.

The above aspects of the present invention are merely some parts of the embodiments of the present invention and various embodiments into which the technical features of the present invention are incorporated can be derived and understood by persons skilled in the art from the following detailed description of the present invention.

### Advantageous Effects

According to the embodiments of the present invention, the following effects are obtained.

First, broadcast messages can be efficiently transmitted to M2M devices.

Second, unnecessary power consumption and the number of physical layer decoding operations of M2M devices can be reduced by selectively decoding a broadcast burst according to state and performance of the M2M devices.

Additional advantages, objects, and features of the invention will be readily understood by the following description or by implementing the present invention by those having ordinary skill in the art based on the following description. In addition, the present invention may obtain unexpected advantages upon implementation of the present invention based on the following description by those skilled in art.

### DESCRIPTION OF DRAWINGS

The accompanying drawings, which are included to provide a further understanding of the invention, illustrate embodiments of the invention and together with the description serve to explain the principle of the invention. However, technical features of the present invention are not limited to a specific drawing and features shown in each drawing may configure a new embodiment by combination.

FIG. 1 is a diagram schematically explaining the configuration of an M2M device and a BS according to an embodiment of the present invention;

FIG. 2 is a flowchart illustrating one of paging methods in idle mode which can be applied to the present invention.

FIG. 3 is a diagram illustrating an exemplary broadcast message transmission method for idle-mode M2M devices according to an embodiment of the present invention; and

FIG. 4 is a diagram illustrating an exemplary broadcast message transmission method for connected-mode M2M devices according to an embodiment of the present invention

### BEST MODE FOR CARRYING OUT THE INVENTION

The embodiments of the present invention provide a method and apparatus for broadcasting a broadcast message in a wireless access system supporting an M2M environment.

The embodiments described hereinbelow are combinations of elements and features of the present invention in prescribed forms. The elements or features may be considered selective unless otherwise mentioned. Each element or feature may be practiced without being combined with other elements or features. In addition, some elements and/or features may be combined with one another to constitute the embodiments of the present invention. Operation orders described in embodiments of the present invention may be rearranged. Some elements or features of one embodiment may be included in another embodiment or may be replaced with corresponding elements or features of another embodiment.

In the description of the drawings, procedures or steps, which may obscure the substance of the present invention, will be avoided. In addition, procedures or steps that could be understood by those skilled in the art will not be described.

In the embodiments of the present invention in this disclosure, a description is given of data transmission and reception between a base station (BS) and a mobile station (MS). Here, the BS refers to a terminal node of a network communicating directly with the MS. In some cases, a specific operation described as being performed by the BS may be performed by an upper node of the BS.

Namely, in a network comprised of a plurality of network nodes including a BS, various operations performed for communication with an MS may be performed by the BS, or network nodes other than the BS. The term ‘BS’ may be replaced with the term fixed station, Node B, eNode B (eNB), advanced base station (ABS), access point, etc.

In addition, the term ‘MS’ may be replaced with the term user equipment (UE), subscriber station (SS), mobile subscriber station (MSS), mobile terminal, advanced mobile station (AMS), terminal, etc. Particularly, in the present invention, MS may have the same meaning as M2M device.

A transmitting end refers to a fixed and/or mobile node which transmits a data service or a voice service and a receiving end refers to a fixed and/or mobile node which receives a data service or a voice service. Therefore, in uplink, an MS may serve as a transmitting end and a BS may serve as a receiving end. Similarly, in downlink, the MS may serve as a receiving end and the BS may serve as a transmitting end.

The embodiments of the present invention may be supported by standard documents disclosed in at least one of wireless access systems including an institute of electrical and electronics engineers (IEEE) 802.xx system, a 3rd general partnership project (3GPP) system, a 3GPP long term evolution (LTE) system, and a 3GPP2 system. That is, obvious steps or portions which are not described in the embodiments of the present invention may be supported by the above documents.

For all terminology used herein, reference may be made to the above standard documents. Especially, the embodiments of the present invention may be supported by at least one of P802.16e-2004, P802.16e-2005, P803.16m, P802.16p, and P802.16.1b which are standard documents of the IEEE 802.16 system.

Reference will now be made in detail to the exemplary embodiments of the present invention in conjunction with the accompanying drawings. The detailed description, which will be given below with reference to the accompanying drawings, is intended to explain exemplary embodiments of the present invention, rather than to show the only embodiments that can be implemented according to the invention. In the drawings, parts that are not related to a description of the present invention are omitted to clearly explain the present invention and the same reference numbers will be used throughout this specification to refer to the same or like parts.

Throughout the disclosure, if it is said that any part “includes” a constituent element, this means that the part may further include other constituent elements rather than excluding other constituent elements unless specified otherwise. In addition, the terms “ . . . part”, “ . . . portion”, and “ . . . module” disclosed herein are used to indicate a unit for processing at least one function or operation, which may be realized by hardware, software, or a combination thereof.

In addition, the specific terms used in the embodiments of the present invention are provided to aid in understanding of the present invention and those terms may be changed without departing from the spirit of the present invention.

1. M2M Device General

Hereinafter, M2M communication refers to communication between terminals via a BS, communication between a BS and terminals without human intervention, or communication between M2M devices. Accordingly, an M2M device refers to a terminal that supports such M2M communication.

An access service network (ASN) for an M2M service is defined as an M2M ASN and a network entity communicating with M2M devices is called an M2M server. The M2M server executes an M2M application and provides an M2M specific service for one or more M2M devices. An M2M feature indicates the feature of an M2M application and one or more features may be necessary to provide the application. An M2M device group refers to a group of M2M devices which share one or more features in common.

Devices performing communication according to an M2M scheme (which may be called M2M devices, M2M communication devices, machine type communication (MTC) devices, etc.) will gradually increase in number in a given network as the types of machine applications thereof increases.

Machine applications include (1) security, (2) public safety, (3) tracking and tracing, (4) payment, (5) healthcare, (6) remote maintenance and control, (7) metering, (8) consumer devices, (9) fleet management in a POS system and a security related application market, (10) M2M communication between vending machines, (11) remote monitoring of machines or facilities, and smart metering of measuring an operating time of construction equipment and automatically measuring heat or electricity use, and (12) surveillance video communication of a surveillance camera. However, the machine application types are not limited to these types and a variety of machine application types are applicable.

Another feature of M2M devices is that they have low mobility or they seldom move once installed. In other words, this implies that the M2M devices are stationary for a considerably long time. An M2M communication system may simplify or optimize mobility-related operations for a specific stationary M2M application such as secured access and surveillance, public safety, payment, remote maintenance and control, and metering.

Thus, as the number of the machine application types increases, the number of M2M communication devices may rapidly increase compared to the number of a general mobile communication devices. Accordingly, if each of the M2M devices individually communicates with a BS, a wireless interface and/or a network may be subject to severe load.

Hereinafter, the embodiments of the present invention will be described when M2M communication is applied to a wireless communication system (e.g. P802.16e, P802.16m, P802.16.1b, P902.16p, etc.). However, the present invention is not limited thereto and is applicable to other communication systems such as a 3GPP LTE/LTE-A system.

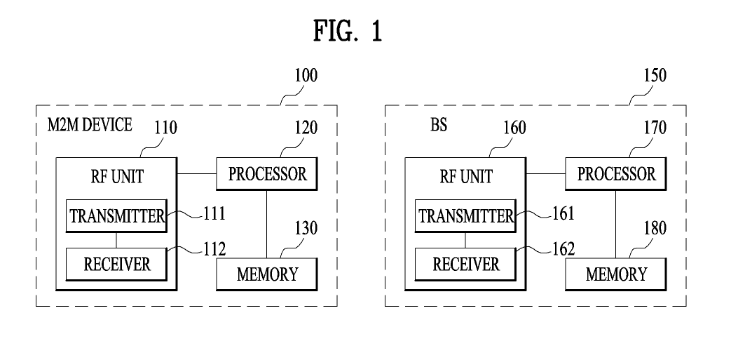

FIG. 1 is a diagram schematically explaining the configuration of an M2M device and a BS according to an embodiment of the present invention.

Referring to FIG. 1, an M2M device 100 may include a radio frequency (RF) unit 110 and a processor 120. ABS 150 may include an RF unit 160 and a processor 170. The M2M device 100 and the BS 150 may selectively include memories 130 and 180, respectively. Although one M2M device and one BS are shown in FIG. 1, an M2M communication environment may be established between a plurality of M2M devices and a BS.

The RF units 110 and 160 may include transmitters 111 and 161, respectively, and receivers 112 and 162, respectively. The transmitter 111 and the receiver 112 of the M2M device 100 are configured to transmit and receive signals to and from the BS 150 and other M2M devices. The processor 120, which is functionally connected to the transmitter 111 and the receiver 112, may be configured to control the transmitter 111 and the receiver 112 to exchange signals with other devices. The processor 120 may process signals to be transmitted and then transmit the processed signals to the transmitter 111, and may process signals received by the receiver 112.

If necessary, the processor 120 may store information included in exchanged messages in the memory 130. With such a configuration, the M2M device 100 may perform methods according to various embodiments of the present invention which will be described later.

Meanwhile, although not shown in FIG. 1, the M2M device 100 may further include a variety of components according to a machine application type thereof. For example, if the M2M device 100 is designed for smart metering, the M2M device 100 may include an additional component for power measurement and an operation for such power measurement may be controlled by the processor 120 shown in FIG. 1 or a separately configured processor (not shown).

While FIG. 1 illustrates an example of communication between the M2M device 100 and the BS 150, an M2M communication method according to the present invention may be performed between one or more M2M devices and each device may carry out methods according to various embodiments, which will be described later, with the same configuration as the configuration of each component illustrated in FIG. 1.

The transmitter 161 and the receiver 162 of the BS 150 are configured to transmit and receive signals to and from another BS, an M2M server, and M2M devices. The processor 170 may be functionally connected to the transmitter 161 and the receiver 162 to control the transmitter 161 and the receiver 162 to transmit and receive signals to and from other devices. The processor 170 may process signals to be transmitted and transmit the processed signals to the transmitter 161, and may process signals received by the receiver 162. If necessary, the processor 170 may store information included in exchanged messages in the memory 180. With such a configuration, the BS 150 may perform methods according to the above described various embodiments of the present invention.

The processors 120 and 170 of the M2M device 110 and the BS 150 direct (e.g. control, adjust, manage, etc.) operations of the M2M 110 and the BS 150, respectively. The processors 120 and 170 may be respectively connected to the memories 130 and 180 which store program code and data. The memories 130 and 180 are connected respectively to the processors 120 and 170 and store operating systems, applications, and general files.

The processors 120 and 170 of the present invention may be called controllers, microcontrollers, microcomputers, etc. Meanwhile, the processors 120 and 170 may be implemented by hardware, firmware, software, or combinations thereof. When the embodiments of the present invention are implemented using hardware, the processors 120 and 170 may include application specific integrated circuits (ASICs), digital signal processors (DSPs), digital signal processing devices (DSPDs), programmable logic devices (PLDs), field programmable gate arrays (FPGAs), or the like, which are configured to implement the present invention.

Meanwhile, when the embodiments of the present invention are implemented using firmware or software, the firmware or software may be configured to include a module, a procedure, or a function which performs the functions or operations of the present invention. The firmware or software configured to be able to perform the present invention may be included in the processors 120 and 170 or may be stored in the memories 130 and 180 so as to be executed by the processors 120 and 170.

2. Idle Mode

Hereinafter, idle mode in an M2M environment in which the embodiments of the present invention are implemented will be described.

Idle mode refers to mode for operating a paging group, a paging cycle, and a paging offset, for power saving when an M2M device (i.e. an MS) has not received traffic from a BS for a predetermined time.

For example, an MS transitioning to idle mode may receive a broadcast message (e.g. a paging message) broadcast by the BS only during a paging available interval (or paging listening interval) of a paging cycle to determine whether to enter normal mode or to remain in an idle state.

The idle mode serves as a mechanism capable of periodically receiving a downlink message without registering in a specific BS (i.e. without performing handover, etc.), even if the MS roams a wireless link environment in which a plurality of BSs is present throughout a wide region.

For convenience of description, the idle mode will be described based on IEEE 802.16e/16 m/16p systems. However, the technical features of the present invention are not limited thereto. To transition to the idle mode, the MS transmits a deregistration request (DREG-REQ) message to the BS to request deregistration with the BS.

Next, the BS transmits a deregistration response (DREG-RSP) message to the MS as a response to the DREG-REQ message. In this case, the DREG-RSP message includes paging information. Transition to the idle mode of the MS may be initiated by the request of the BS (in an unsolicited manner). At this time, the BS transmits the DREG-RSP message to the MS.

The paging information may include a paging cycle, a paging offset, a paging group identifier (PGID), and a paging listening interval value.

Upon receipt of the DREG-RSP message from the BS, the MS transitions to the idle mode with reference to the paging information. The idle mode has a paging cycle and one paging cycle is composed of a paging listening interval and an unavailable interval. The paging listening interval may be interpreted as the same meaning as an available interval or a paging interval.

The paging offset represents a timing (as an example, a frame or a subframe) at which the paging listening interval is started in the paging cycle. The PGID indicates an ID of a paging group allocated to the MS. The paging information may include paging message offset information. The paging offset information indicates a timing at which a paging message is transmitted from the BS.

Next, the MS may receive the paging message transmitted thereto in the paging listening interval using the paging information. The paging message may be transmitted through the BS or a paging controller. That is, the MS monitors a radio channel according to the paging cycle in order to receive the paging message.

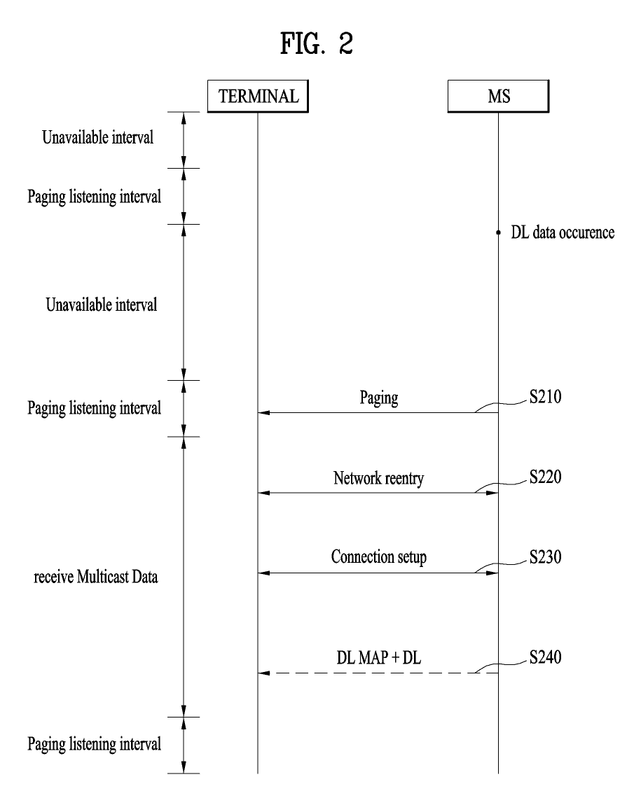

FIG. 2 is a flowchart illustrating one of paging methods in idle mode which can be applied to the present invention.

If downlink (DL) data occurs with respect to an MS of idle mode in a paging group to which a BS belongs, the BS may transmit a paging message to inform the MS of occurrence of the DL data. The MS receives the paging message in a paging listening interval to check whether the DL data transmitted thereto is present (S210).

If the DL data is present (i.e. positive indication), the MS performs a network reentry procedure including a ranging procedure (S220). Next, the MS performs a connection setup procedure for setting up connection for an associated DL service flow through a dynamic service addition (DSA) procedure with the BS (S230).

After the connection setup procedure for the service flow, the BS transmits DL control information for a corresponding service and the DL data to the MS (S240).

In an M2M scenario, since most M2M devices are not carried by a user unlike normal MSs such as a cellular phone, an automatic application or a firmware update process for the M2M devices may be a main application in an M2M service scenario.

For example, to update firmware of each device, an M2M server may transmit updated information to M2M devices having a corresponding application. To transmit such multicast data which needs to be commonly transmitted to M2M devices in idle mode, the BS pages the M2M devices through the paging procedure described in FIG. 2.

The paged devices transmit a random access code, perform the network reentry procedure to access a network, and receive DL traffic transmitted by the BS.

3. Method for Transmitting Broadcast Message for M2M Devices

(1) Broadcast Message Transmission

In an IEEE 802.16 m/16.1 system, a broadcast message is generally transmitted through a broadcast burst, which is a type of data burst. That is, the broadcast message broadcast in a specific BS is transmitted to all MSs in a cell area of the BS. Unlike IEEE 802.16 Rev3 specification, in an IEEE 802.16.1 system (hereinafter, 16.1 system), an advance MS (AMS) should decode all broadcast bursts for all MAC control messages.

Broadcast MAC control messages defined in the 16.1 system include an advanced air interface-system configuration descriptor (AAI-SCD) message, an AAI-service identity information advertisement (AAI-SII-ADV) message, an AAI-uplink power control-noise and interference level broadcast (AAI-ULPC-NI) message, an AAI-ranging request (AAI-RNG-REQ) message, an AAI-ranging acknowledgement (AAI-RNG-ACK) message, an AAI-traffic indicator (AAI-TRF-IND) message, an AAI-neighbor BS advertisement (AAI-NBR-ADV) message, an AAI-paging advertisement (AAI-PAG-ADV) message, a paging group identifier information (PGID-Info) message, an AAI-multicarrier advertisement (AAI-MC-ADV) message, an AAI-DL interference mitigation (AAI-DL-IM) message, an AAI-self organizing and optimizing network advertisement (AAI-SON-ADV) message, an AAI-L2 transfer (AAI-L2-XFER) message, and an AAI-location based service advertisement (AAI-LBS-ADV) message.

However, since the above-described broadcast messages differ in transmission purposes thereof, some MSs need not decode all the broadcast MAC control messages. Accordingly, some MSs unnecessarily receive and decode broadcast messages or multicast messages (e.g. AAI-SCD, AAI-PAG-ADV, PGID-Info, and AAI-TRF-IND messages) that the MSs do not need to receive. Such an operation may cause significant power consumption in MSs for minimizing power consumption, such as M2M devices.

For example, M2M devices in active mode do not need to decode messages such as a paging advertisement (AAI-PAG-ADV) message, a paging information (PGID-INFO) message, and/or a traffic indicator (AAI-TRF-IND) message, targeted for MSs of a power saving mode state.

In addition, M2M devices which are not in sleep mode do not need to decode a multicast transmission end indication (AAI-MTE-IND) message. Furthermore, M2M devices which are not in idle mode do not need to decode a PGID-Info message or an AAI-PAG-ADV message. This is because such messages are not frequently transmitted if there are not many idle-mode M2M devices in a paging group. The M2M devices in the idle mode receive M2M multicast data even upon not re-entering a network and do not decode a broadcast burst of a ranging response message. This message is frequently transmitted when there are many devices attempting to perform ranging.

Moreover, fixed M2M devices need not decode a broadcast burst for a neighbor BS advertisement (AAI-NRB-ADV) message. Most M2M devices may be fixed as a smart meter, a vending machine, etc. M2M devices having no multicarrier (MC) performance need not decode a broadcast burst of an AAI-MC-ADV message. Notably, most M2M devices transmitting packets (e.g. a smart meter) do not have MC performance.

M2M devices not having E-MBS performance or E-MBS connection information (e.g. E-MBS IDs and FIDs) need not decode a broadcast burst of an AAI-E-MBS-CFG message. This is because most M2M devices have no MC performance and the AAI-E-MBS-CFG message is transmitted every 32 superframes. M2M devices do not decode a broadcast burst of an AAI-SCD message unless information of the AAI-SCD message is changed.

Other broadcast messages except for the above-mentioned messages are not frequently transmitted from an ABS. Therefore, after decoding broadcast bursts of other messages, M2M devices determine whether to read other broadcast messages.

As described above, necessary broadcast messages differ according to current states and types of M2M devices. Accordingly, if M2M devices decode all broadcast bursts in order to receive all broadcast messages, decoding processes of physical layers of the M2M devices and power consumption may be increased.

Accordingly, the embodiments of the present invention disclose various methods for minimizing decoding processes in physical layers of M2M devices and power consumption. That is, the embodiments of the present invention which will be described below provide methods capable of selectively decoding broadcast bursts by M2M devices.

(2) Broadcast Assignment a-MAP Information Element (BA A-MA) IE)

A broadcast assignment (BA) A-MAP information element (IE) is transmitted to assign resources for a broadcast burst, a multicast burst, and/or a non-synchronized ranging channel (NS-RCH). The broadcast burst may include one or more broadcast MAC control messages. The following Table 1 indicates one of the structures of the BA A-MAP IE which can be used in the embodiments of the present invention.

TABLE 1

| | Size | |
|---|---|---|
| Syntax | (bits) | Notes |
| Broadcast_Assignment_A- | | |
| MAP_IE( ){ | | |
| A-MAP IE Type | 4 | Broadcast Assignment A-MAP IE |
| Function index | 2 | 0b00: This IE carries broadcast assignment |
| | | information |
| | | 0b01: This IE carries handover ranging channel |
| | | allocation information |
| | | 0b10: This IE carries multicast assignment |
| | | information |
| | | 0b11: Reserved |
| If(Function index ==0b00){ | | |
| Burst Size | 6 | Burst size as indicated in the first 39 entries in Table |
| | | 303 |
| Resource Index | 11 | 512 FFT size: 0 in first 2 MSB bits + 9 bits for |
| | | resource index |
| | | 1024 FFT size: 11 bits for resource index |
| | | 2048 FFT size: 11 bits for resource index |
| | | Resource index includes location and allocation size. |
| Long TTI Indicator | 1 | Indicates number of AAI subframes spanned by the |
| | | allocated resource. |
| | | 0b0: 1 AAI subframe (default TTI) |
| | | 0b1: 4 DL AAI subframe for FDD or all DL AAI |
| | | subframes for TDD (long TTI) |
| Transmission Format | 1 | 0b0: on time domain repetition |
| If(Transmission format | | 0b1: with time domain repetition |
| ==0b1){ | | |
| Repetition | 2 | 0b00: no more repetition of the same burst |
| | | 0b01: the same burst shall be transmitted one more |
| | | time |
| | | 0b10: the same burst shall be transmitted two more |
| | | times |
| | | 0b11: the same burst shall be transmitted three more |
| | | time. |
| Reserved | 13 | reserved bits |
| }else{ | | |
| Reserved | 15 | reserved bits |
| } | | |
| }else if(Function Index == | | |
| 0b01){ | | |
| Number of Ranging | 1 | 0: one NS-RCH1: two NS-RCHs |
| Opportunities (N) | | |
| for(i=0; i<N; i++){ | | |
| Subframe Index | 3 | |
| Ranging opportunity index | 1 | Indicates 2-bit Opportunity index of the ranging |
| | | channel specified in 6.2.15.30b0:0b010b1:0b10 |
| } | | |
| Reserved | 29/25 | |
| }else if (Function | | |
| Index==0b10){ | | |
| Multicast Group ID | 12 | ID of a group that receives multicast assignment |
| Burst Size | 6 | burst size as indicated in the first 39 entries in Table |
| | | 307 |
| Resource Index | 11 | 512 FFT size: 0 in first 2 MSB bits + 9 bits for |
| | | resource index |
| | | 1024 FFT size: 11 bits for resource index |
| | | 2048 FFT size: 11 bits for resource index |
| | | Resource index includes location and allocation size. |
| Long TTI indicator | 1 | Indicates number of AAI subframes spanned by the |
| | | allocated resource. |
| | | 0b0: 1 AAI subframe (default TTI) |
| | | 0b1: 4 DL AAI subframe for FDD or all DL AAI |
| | | subframes for TDD (long TTI) |
| Reserved | 4 | reserved bits |
| } | | |

A detailed operation of fields included in the BA A-MAP IE is described in Table 1. In Table 1, if a function index indicates 0b00, the BA A-MAP IE includes broadcast resource assignment information, that is, a broadcast burst through which a broadcast message is transmitted.

For example, the BA-A MAP IE may further include resource assignment information (e.g. one or more of a burst size field, a resource index field, a long TTI indicator field, a transmission format field, and a multicast group ID field) for corresponding broadcast transmission and/or multicast transmission according to a setting value of the function index.

In the embodiments of the present invention, a message type field indicating the type of the broadcast message may be included in the BA A-MAP IE so that an M2M device receiving the BA A-MAP IE determines whether to decode the broadcast burst based on a state thereof and the message type field. For instance, the M2M device may determine whether to decode the broadcast burst through which the broadcast message is transmitted based on the message type field included in the BA A-MAP IE field.

The following Table 2 shows an exemplary BA A-MAP IE format including a message type field of a bitmap format.

TABLE 2

| | Size | |
|---|---|---|
| Syntax | (bits) | Notes |
| Broadcast_Assignment_A- | | |
| MAP_IE( ){ | | |
| A-MAP_IE Type | 4 | Broadcast Assignment A-MAP IE |
| Function index | 2 | 0b00: This IE carries broadcast assignment |
| | | information |
| | | 0b01: This IE carries handover ranging channel |
| | | allocation information |
| | | 0b10: This IE carries multicast assignment |
| | | information |
| | | 0b11: This IE carries ranging channel allocation |
| | | information for M2M devices |
| If(Function index ==0b00){ | | |
| Burst Size | 6 | Burst size as indicated in the first 39 entries in Table |
| | | 954 |
| Resource Index | 11 | 512 FFT size: 0 in first 2 MSB bits + 9 bits for |
| | | resource index |
| | | 1024 FFT size: 11 bits for resource index |
| | | 2048 FFT size: 11 bits for resource index |
| | | Resource index includes location and allocation size. |
| Long TTI Indicator | 1 | Indicates number of AAI subframes spanned by the |
| | | allocated resource. |
| | | 0b0: 1 AAI subframe (default TTI) |
| | | 0b1: 4 DL AAI subframe for FDD or all DL AAI |
| | | subframes for TDD (long TTI) |
| Transmission Format | 1 | 0b0: on time domain repetition |
| | | 0b1: with time domain repetition |
| If(Transmission format | | |
| ==0b1){ | | |
| Repetition | 2 | 0b00: no more repetition of the same burst |
| | | 0b01: the same burst shall be transmitted one more |
| | | time. |
| | | 0b10: the same burst shall be transmitted two more |
| | | times. |
| | | 0b11: the same burst shall be transmitted three more |
| | | time. |
| Message Type Bitmap | 8 | Indicates the type bitmap of broadcast MAC control |
| | | messages included in this burst. This bitmap is used |
| | | only for M2M devices. |
| | | Bit #0: AAI-SCD |
| | | Bit #1: AAI-TRF-IND |
| | | Bit #2: AAI-PAG-ADV/PGID-Info |
| | | Bit #3: AAI-RNG-ACK |
| | | Bit#4: AAI-NBR-ADV |
| | | Bit#5: AAI-MC-ADV |
| | | Bit #6: AAI-E-MBS-CFG |
| | | Bit #7: Other broadcast MAC control messages |
| Reserved | 5 | reserved bits |
| }else{ | | |
| Message Type Bitmap | 8 | Indicates the type bitmap of broadcast MAC control |
| | | messages included in this burst. This bitmap is used |
| | | only for M2M devices. |
| | | Bit #0: AAI-SCD |
| | | Bit#1: AAI-TRF-IND |
| | | Bit#2: AAI-PAG-ADV/PGID-Info |
| | | Bit #3: AAI-RNG-ACK |
| | | Bit#4: AAI-NBR-ADV |
| | | Bit#5: AAI-MC-ADV |
| | | Bit#6: AAI-E-MBS-CFG |
| | | Bit#7: Other broadcast MAC control messages |
| Reserved | 7 | reserved bits |
| } | | |
| }else if(Function Index == | | |
| 0b01){ | | |
| . . . | . . . | . . . |
| else {//Function Index == | | |
| 0b11 | | |
| Number of Ranging | 1 | 0: one NS-RCH1: two NS-RCHs |
| Opportunities (N) | | |
| for(i=0; i<N; i++){ | | |
| Subframe Index | 3 | |
| Ranging opportunity index | 1 | Indicates 2-bit Opportunity index of the ranging |
| | | channel specified in 16.2.15.3. |
| | | 0b0: 0b01 |
| | | 0b1: 0b10 |
| Dedicated Ranging Indicator | 1 | 0: this ranging channel is used for purpose of normal |
| | | ranging |
| | | 1: this ranging channel is used for the purpose of |
| | | dedicated ranging indicated in the AAI-PAG-ADV |
| | | message |
| } | | |
| Reserved | 29/25 | |
| } | | |
| } | | |
| } | | |

Referring to Table 2, a BA A-MAP IE may include an 8-bit message type bitmap field and resource assignment information indicating an assignment region of a broadcast burst through which a broadcast message is transmitted.

In this case, the message type bitmap field indicates a broadcast message (i.e. broadcast MAC control message) included in a broadcast burst in a bitmap format. For example, the first bit of the message type bitmap field indicates an AAI-SCD message, the second bit thereof indicates an AAI-TRF-IND message, the third bit thereof indicates an AAI-PAG-ADV/PGID-Info message, the fourth bit thereof indicates an AAI-RNG-ACK message, the fifth bit thereof indicates an AAI-NBR-ADV message, the sixth bit thereof indicates an AAI-MC-ADV message, and the seventh bit thereof indicates an AAI-E-MBS-CFG message.

Further, the last bit (bit #7) in the message type bitmap field represents that broadcast messages other than the 7 message types indicated by the other bits are transmitted through the corresponding broadcast burst. Accordingly, if the last bit is set to 1, the M2M device should always decode the broadcast burst irrespective of how the other bits are set.

In Table 2, if a function index is set to 0b00, the M2M device receiving the BA A-MAP IE may confirm the broadcast MAC control message included in the broadcast burst indicated in the BA A-MAP IE based on the message type bitmap field and may selectively receive broadcast messages necessary therefor.

The following Table 3 illustrates an exemplary BA A-MAP IE format including a message type field of an index format

TABLE 3

| | Size | |
|---|---|---|
| Syntax | (bits) | Notes |
| Broadcast_Assignment_A- | | |
| MAP_IE( ){ | | |
| A-MAP IE Type | 4 | Broadcast Assignment A-MAP IE |
| Function index | 2 | 0b00: This IE carries broadcast assignment |
| | | information |
| | | 0b01: This IE carries handover ranging channel |
| | | allocation information |
| | | 0b10: This IE carries multicast assignment |
| | | information |
| | | 0b11: This IE carries ranging channel allocation |
| | | information for M2M devices |
| If(Function index ==0b00){ | | |
| Burst Size | 6 | Burst size as indicated in the first 39 entries in Table |
| | | 954 |
| Resource Index | 11 | 512 FFT size: 0 in first 2 MSB bits + 9 bits for |
| | | resource index |
| | | 1024 FFT size: 11 bits for resource index |
| | | 2048 FFT size: 11 bits for resource index |
| | | Resource index includes location and allocation size. |
| Long TTI Indicator | 1 | Indicates number of AAI subframes spanned by the |
| | | allocated resource. |
| | | 0b0: 1 AAI subframe (default TTI) |
| | | 0b1: 4 DL AAI subframe for FDD or all DL AAI |
| | | subframes for TDD (long TTI) |
| Transmission Format | 1 | 0b0: on time domain repetition |
| | | 0b1: with time domain repetition |
| If(Transmission format | | |
| ==0b1){ | | |
| Repetition | 2 | 0b00: no more repetition of the same burst |
| | | 0b01: the same burst shall be transmitted one more |
| | | time. 0b10: the same burst shall be transmitted two |
| | | more times. |
| | | 0b11: the same burst shall be transmitted three more |
| | | time. |
| Message Type index | TBD | Type of MAC control message included in this burst |
| | | 0x0: AAI-SCD |
| | | 0x1: AAI-SII-ADV |
| | | 0x2: AAI-ULPC-NI |
| | | 0x3: AAI-RNG-ACK |
| | | 0x4: AAI-TRF-IND |
| | | 0x5: AAI-NBR-ADV |
| | | 0x6: AAI-PAG-ADV |
| | | 0x7: PGID-Info |
| | | 0x8: AAI-MC-ADV |
| | | 0x9: AAI-DL-IM |
| | | 0xa: AAI-SON-ADV |
| | | 0xb: AAI-E-MBS-CFG |
| | | 0xc: AAI-L2-XFER |
| | | 0xd: AAI-LBS-ADV |
| | | 0xe: reserved |
| | | 0xf: Indicates that this burst includes the multiple |
| | | MAC messages. All MSs shall decode this burst. |
| Reserved | TBD | reserved bits |
| }else{ | | |
| Message Type Index | TBD | Type of MAC control message included in this burst |
| | | 0x0: AAI-SCD |
| | | 0x1: AAI-SII-ADV |
| | | 0x2: AAI-ULPC-NI |
| | | 0x3: AAI-RNG-ACK |
| | | 0x4: AAI-TRF-IND |
| | | 0x5: AAI-NBR-ADV |
| | | 0x6: AAI-PAG-ADV |
| | | 0x7: PGID-Info |
| | | 0x8: AAI-MC-ADV |
| | | 0x9: AAI-DL-IM |
| | | 0xa: AAI-SON-ADV |
| | | 0xb: AAI-E-MBS-CFG |
| | | 0xc: AAI-L2-XFER |
| | | 0xd: AAI-LBS-ADV |
| | | 0xe: reserved |
| | | 0xf: Indicates that this burst includes the multiple |
| | | MAC messages. All MSs shall decode this burst. |
| Reserved | TBD | reserved bits |
| } | | |
| }else if(Function Index == | | |
| 0b01){ | | |
| . . . | . . . | . . . |
| } | | |
| } | | |
| } | | |

Referring to Table 3, a BA A-MAP IE may include a message type index field and resource assignment information indicating an assignment region of a broadcast burst through which a broadcast message is transmitted.

In this case, the message type index field may indicate one of an AAI-SCD message, an AAI-SII-ADV message, an AAI-ULPC-NI message, an AAI-RNG-ACK message, an AAI-TRF-IND message, an AAI-NBR-ADV message, an AAI-PAG-ADV message, a PGID-Info message, an AAI-MC-ADV message, an AAI-DL-IM message, an AAI-SON-ADV message, an AAI-E-MBS-CFG message, an AAI-L2-XFER message, and an AAI-LBS-ADV message.

Notably, if the message type index field is set to ‘0xf’, this indicates that broadcast messages other than the above-described broadcast messages are transmitted through the corresponding broadcast burst. Accordingly, if the message type index field is set to ‘0xf’, the M2M device always decodes the broadcast burst to determine whether to decode a corresponding broadcast MAC control message by interpreting a MAC message type in the MAC control message.

The following Table 4 illustrates another exemplary BA A-MAP IE format including a message type field of a bitmap format.

TABLE 4

| Syntax | Size (bits) | Notes |
|---|---|---|
| Broadcast_Assignment_A- | | |
| MAP_IE( ){ | | |
| A-MAP IE Type | 4 | Broadcast Assignment A-MAP IE |
| Function index | 2 | 0b00: This IE carries broadcast assignment |
| | | information |
| | | 0b01: This IE carries handover ranging channel |
| | | allocation information |
| | | 0b10: This IE carries multicast assignment |
| | | information |
| | | 0b11: This IE carries ranging channel allocation |
| | | information for M2M devices |
| If(Function index ==0b00){ | | |
| Burst Size | 6 | Burst size as indicated in the first 39 entries in |
| | | Table 954 |
| Resource Index | 11 | 512 FFT size: 0 in first 2 MSB bits + 9 bits for |
| | | resource index |
| | | 1024 FFT size: 11 bits for resource index |
| | | 2048 FFT size: 11 bits for resource index |
| | | Resource index includes location and allocation |
| | | size. |
| Long TTI Indicator | 1 | Indicates number of AAI subframes spanned by |
| | | the allocated resource. |
| | | 0b0: 1 AAI subframe (default TTI) |
| | | 0b1: 4 DL AAI subframe for FDD or all DL |
| | | AAI subframes for TDD (long TTI) |
| Transmission Format | 1 | 0b0: on time domain repetition |
| | | 0b1: with time domain repetition |
| If(Transmission format | | |
| ==0b1){ | | |
| Repetition | 2 | 0b00: no more repetition of the same burst0b01: |
| | | the same burst shall be transmitted one more |
| | | time. |
| | | 0b10: the same burst shall be transmitted two |
| | | more times. |
| | | 0b11: the same burst shall be transmitted three |
| | | more time. |
| Message Type Bitmap | TBD | Each bit indicates the type of MAC control |
| | (e.g., 13) | message included in broadcast burst e.g.,) |
| | | Bit #0: AAI-SCD |
| | | Bit #1: AAI-SII-ADV |
| | | Bit #2: AAI-ULPC-NI |
| | | Bit #3: AAI-RNG-ACK |
| | | Bit #4: AAI-TRF-IND |
| | | Bit #5: AAI-NBR-ADV |
| | | Bit #6: AAI-PAG-ADV |
| | | Bit #7: PGID-Info |
| | | Bit #8: AAI-MC-ADV |
| | | Bit #9: AAI-DL-IM |
| | | Bit #10: AAI-SON-ADV |
| | | Bit #11: AAI-E-MBS-CFG |
| | | Bit #12: AAI-L2-XFER |
| | | Bit #13: AAI-LBS-ADV |
| Reserved | 5 | reserved bits |
| }else{ | | |
| Message Type Bitmap | TBD | Each bit indicates the type of MAC control |
| | (e.g., 13) | message included in broadcast burste.g.,) |
| | | Bit #0: AAI-SCD |
| | | Bit #1: AAI-SII-ADV |
| | | Bit #2: AAI-ULPC-NI |
| | | Bit #3: AAI-RNG-ACK |
| | | Bit #4: AAI-TRF-IND |
| | | Bit #5: AAI-NBR-ADV |
| | | Bit #6: AAI-PAG-ADV |
| | | Bit #7: PGID-InfoBit #8: AAI-MC-ADV |
| | | Bit #9: AAI-DL-IM |
| | | Bit #10: AAI-SON-ADV |
| | | Bit #11: AAI-E-MBS-CFG |
| | | Bit #12: AAI-L2-XFER |
| | | Bit #13: AAI-LBS-ADV |
| Reserved | 7 | reserved bits |
| } | | |
| }else if(Function Index == | | |
| 0b01){ | | |
| . . . | . . . | . . . |
| } | | |
| } | | |
| } | | |

Referring to Table 4, a BA A-MAP IE may include a message type bitmap field and resource assignment information indicating an assignment region of a broadcast burst through which a broadcast message is transmitted.

In this case, the message type bitmap field indicates a broadcast MAC control message included in the broadcast burst in a bitmap format. For example, each bit of the message type bitmap field may include an AAI-SCD message, an AAI-SII-ADV message, an AAI-ULPC-NI message, an AAI-RNG-ACK message, an AAI-TRF-IND message, an AAI-NBR-ADV message, an AAI-PAG-ADV message, a PGID-Info message, an AAI-MC-ADV message, an AAI-DL-IM message, an AAI-SON-ADV message, an AAI-E-MBS-CFG message, an AAI-L2-XFER message, and an AAI-LBS-ADV message.

The following Table 5 illustrates another exemplary BA A-MAP IE format including a message type field of a bitmap format.

TABLE 5

| Syntax | Size (bits) | Notes |
|---|---|---|
| Broadcast_Assignment_A- | | |
| MAP_IE( ){ | | |
| A-MAP IE Type | 4 | Broadcast Assignment A-MAP IE |
| Function index | 2 | 0b00: This IE carries broadcast assignment |
| | | information |
| | | 0b01: This IE carries handover ranging channel |
| | | allocation information |
| | | 0b10: This IE carries multicast assignment |
| | | information |
| | | 0b11: This IE carries ranging channel |
| | | allocation information for M2M devices |
| If(Function index ==0b00){ | | |
| Burst Size | 6 | Burst size as indicated in the first 39 entries in |
| | | Table 954 |
| Resource Index | 11 | 512 FFT size: 0 in first 2 MSB bits + 9 bits for |
| | | resource index |
| | | 1024 FFT size: 11 bits for resource index |
| | | 2048 FFT size: 11 bits for resource index |
| | | Resource index includes location and allocation |
| | | size. |
| Long TTI Indicator | 1 | Indicates number of AAI subframes spanned by |
| | | the allocated resource. |
| | | 0b0: 1 AAI subframe (default TTI) |
| | | 0b1: 4 DL AAI subframe for FDD or all DL |
| | | AAI subframes for TDD (long TTI) |
| Transmission Format | 1 | 0b0: on time domain repetition |
| | | 0b1: with time domain repetition |
| If(Transmission format ==0b1){ | | |
| Repetition | 2 | 0b00: no more repetition of the same burst |
| | | 0b01: the same burst shall be transmitted one |
| | | more time. |
| | | 0b10: the same burst shall be transmitted two |
| | | more times. |
| | | 0b11: the same burst shall be transmitted three |
| | | more time. |
| Message Type Bitmap | TBD | Each bit indicates the type of MAC control |
| | (e.g., 9) | message included in broadcast burste.g.,) |
| | | Bit #0: AAI-SCD |
| | | Bit #1: AAI-TRF-IND |
| | | Bit #2: AAI-PAG-ADV/PGID-Info |
| | | Bit #3: AAI-RNG-ACK |
| | | Bit #4: AAI-NBR-ADV |
| | | Bit #5: AAI-E-MBS-CFG |
| | | Bit #6: AAI-LBS-ADV |
| | | Bit #7: AAI-MC-ADV |
| | | Bit #8: Indicate if all device decodes this |
| | | broadcast burst |
| Reserved | 5 | reserved bits |
| }else{ | | |
| Message Type Bitmap | TBD | Each bit indicates the type of MAC control |
| | (e.g., 9) | message included in broadcast burst e.g.,) |
| | | Bit#0: AAI-SCD |
| | | Bit #1: AAI-TRF-IND |
| | | Bit #2: AAI-PAG-ADV/PGID-Info |
| | | Bit #3: AAI-RNG-ACK |
| | | Bit #4: AAI-NBR-ADV |
| | | Bit #5: AAI-E-MBS-CFG |
| | | Bit #6: AAI-LBS-ADV |
| | | Bit #7: AAI-MC-ADV |
| | | Bit #8: Indicate if all device decodes this |
| | | broadcast burst |
| Reserved | 7 | reserved bits |
| } | | |
| }else if(Function Index == | | |
| 0b01){ | | |
| . . . | . . . | . . . |
| } | | |
| } | | |
| } | | |

Referring to Table 5, a BA A-MAP IE may include a message type bitmap field and resource allocation information indicating an assignment region of a broadcast burst through which a broadcast message is transmitted.

In this case, the message type bitmap field indicates a broadcast MAC control message included in the broadcast burst in a bitmap format. For example, each bit of the message type bitmap field may indicate an AAI-SCD message, an AAI-TRF-IND message, an AAI-PAG-ADV/PGID-Info message, an AAI-RNG-ACK message, an AAI-NBR-ADV message, an AAI-E-MBS-CFG message, an AAI-LBS-ADV message, and an AAI-MC-ADV message.

In addition, the last bit (bit #8) of the message type bitmap field represents that broadcast messages other than the 8 message types indicated by other bits are transmitted through the corresponding broadcast burst. Accordingly, if the last bit is set to 1, the M2M device should always decode the broadcast burst irrespective of how the other bits are set.

In Table 5, if a function index is set to 0b00, the M2M device receiving the BA A-MAP IE may confirm the broadcast MAC control message included in the broadcast burst indicated in the BA A-MAP IE based on the message type bitmap field and may selectively receive broadcast messages necessary therefor.

In Table 2, Table 4, and Table 5, types of a broadcast MAC control message transmitted through a broadcast burst of a BA A-MAP IE message are shown in a bitmap format. Accordingly, the size of the message type bitmap is not limited to the size shown in Table 2, Table 4, and Table 5 and may vary according to the number of broadcast messages actually transmitted through the BA A-MAP IE message.

The following Table 6 illustrates an exemplary BA A-MAP IE format including message type fields of an index format and a bitmap format.

TABLE 6

| Syntax | Size (bits) | Notes |
|---|---|---|
| Broadcast_Assignment_A- | | |
| MAP_IE( ){ | | |
| A-MAP IE Type | 4 | Broadcast Assignment A-MAP IE |
| Function index | 2 | 0b00: This IE carries broadcast assignment |
| | | information |
| | | 0b01: This IE carries handover ranging channel |
| | | allocation information |
| | | 0b10: This IE carries multicast assignment |
| | | information |
| | | 0b11: This IE carries ranging channel allocation |
| | | information for M2M devices |
| If(Function index ==0b00){ | | |
| Burst Size | 6 | Burst size as indicated in the first 39 entries in |
| | | Table 954 |
| Resource Index | 11 | 512 FFT size: 0 in first 2 MSB bits + 9 bits for |
| | | resource index |
| | | 1024 FFT size: 11 bits for resource index |
| | | 2048 FFT size: 11 bits for resource index |
| | | Resource index includes location and allocation |
| | | size. |
| Long TTI Indicator | 1 | Indicates number of AAI subframes spanned by |
| | | the allocated resource. |
| | | 0b0: 1 AAI subframe (default TTI) |
| | | 0b1: 4 DL AAI subframe for FDD or all DL AAI |
| | | subframes for TDD (long TTI) |
| Transmission Format | 1 | 0b0: on time domain repetition0b1: with time |
| | | domain repetition |
| If(Transmission format | | |
| ==0b1){ | | |
| Repetition | 2 | 0b00: no more repetition of the same burst |
| | | 0b01: the same burst shall be transmitted one |
| | | more time. |
| | | 0b10: the same burst shall be transmitted two |
| | | more times. |
| | | b11: the same burst shall be transmitted three |
| | | more time. |
| Mode Indicator | 1 | 0: Message Type Index1: Message Type Bitmap |
| IF(Mode indicator==0b0){ | | |
| Message Type Index | TBD | Type of MAC control message included in this |
| | (e.g., 4) | burst |
| | | 0x0: AAI-SCD |
| | | 0x1: AAI-SII-ADV |
| | | 0x2: AAI-ULPC-NI |
| | | 0x3: AAI-RNG-ACK |
| | | 0x4: AAI-TRF-IND |
| | | 0x5: AAI-NBR-ADV |
| | | 0x6: AAI-PAG-ADV |
| | | 0x7: PGID-Info |
| | | 0x8: AAI-MC-ADV |
| | | 0x9: AAI-DL-IM |
| | | 0xa: AAI-SON-ADV |
| | | 0xb: AAI-E-MBS-CFG |
| | | 0xc: AAI-L2-XFER |
| | | 0xd: AAI-LBS-ADV |
| | | 0xe: reserved |
| | | 0xf: Indicates that this burst includes the multiple |
| | | MAC messages. All MSs shall decode this burst. |
| }else{ | | |
| Message Type Bitmap | 8 | Indicates the type bitmap of broadcast MAC |
| | | control messages included in this burst. This |
| | | bitmap is used only for M2M devices. |
| | | Bit #0: AAI-SCD |
| | | Bit #1: AAI-TRF-IND |
| | | Bit #2: AAI-PAG-ADV/PGID-Info |
| | | Bit #3: AAI-RNG-ACK |
| | | Bit #4: AAI-NBR-ADV |
| | | Bit #5: AAI-MC-ADV |
| | | Bit #6: AAI-E-MBS-CFG |
| | | Bit #7: Other broadcast MAC control messages |
| Reserved | 5 | reserved bits |
| }else{ | | |
| Mode Indicator | 1 | 0: Message Type Index |
| | | 1: Message Type Bitmap |
| If(Mode Indicator ==0b0){ | | |
| Message Type index | TBD | Type of MAC control message included in this |
| | (e.g., 4) | burst |
| | | 0x0: AAI-SCD |
| | | 0x1: AAI-SII-ADV |
| | | 0x2: AAI-ULPC-NI |
| | | 0x3: AAI-RNG-ACK |
| | | 0x4: AAI-TRF-IND |
| | | 0x5: AAI-NBR-ADV |
| | | 0x6: AAI-PAG-ADV |
| | | 0x7: PGID-Info |
| | | 0x8: AAI-MC-ADV |
| | | 0x9: AAI-DL-IM |
| | | 0xa: AAI-SON-ADV |
| | | 0xb: AAI-E-MBS-CFG |
| | | 0xc: AAI-L2-XFER |
| | | 0xd: AAI-LBS-ADV |
| | | 0xe: reserved0xf: Indicates that this burst includes |
| | | the multiple MAC messages. All MSs shall |
| | | decode this burst. |
| }else{ | | |
| Message Type Bitmap | 8 | Indicates the type bitmap of broadcast MAC |
| | | control messages included in this burst. This |
| | | bitmap is used only for M2M devices. |
| | | Bit #0: AAI-SCD |
| | | Bit #1: AAI-TRF-IND |
| | | Bit #2: AAI-PAG-ADV/PGID-Info |
| | | Bit #3: AAI-RNG-ACK |
| | | Bit #4: AAI-NBR-ADV |
| | | Bit #5: AAI-MC-ADV |
| | | Bit #6: AAI-E-MBS-CFG |
| | | Bit #7: Other broadcast MAC control messages |
| } | | |
| Reserved | 5 | reserved bits |
| } | | |
| }else if(Function Index == | | |
| 0b01){ | | |
| . . . | . . . | . . . |
| else {//Function Index == | | |
| 0b11 | | |
| Number of Ranging | 1 | 0: one NS-RCH1: two NS-RCHs |
| Opportunities (N) | | |
| for(i=0; i<N; i++){ | | |
| Subframe Index | 3 | |
| Ranging opportunity index | 1 | Indicates 2-bit Opportunity index of the ranging |
| | | channel specified in 16.2.15.3. |
| | | 0b0: 0b01 |
| | | 0b1: 0b10 |
| Dedicated Ranging Indicator | 1 | 0: this ranging channel is used for purpose of |
| | | normal ranging |
| | | 1: this ranging channel is used for the purpose of |
| | | dedicated ranging indicated in the AAI-PAG- |
| | | ADV message |
| } | | |
| Reserved | 29/25 | |
| } | | |
| } | | |
| } | | |

Referring to Table 6, a BA A-MAP IE may include a 4-bit message type index field or an 8-bit message type bitmap field and resource assignment information indicating an assignment region of a broadcast burst through which a broadcast message is transmitted.

Since the message type index field uses bits less than bits used in the message type bitmap field, the size of the BA A-MAP IE can be reduced. However, the message type index field is disadvantageous in that the field may indicate only whether one broadcast MAC control message is transmitted. Therefore, the BS may adaptively indicate the type of a broadcast message to be transmitted in a bitmap format or an index format by discerning characteristics of MSs in a cell area thereof. To this end, the BA A-MAP IE may further include a mode indicator field. If the mode indicator field is set to ‘0’, this may indicate a message type index and, if the mode indicator field is set to ‘1’, this may indicate a message type bitmap index.

In Table 6, the broadcast MAC control messages indicated in the message type index field and the message type bitmap field are purely exemplary and other broadcast MAC control messages may be indicated.

(3) Efficient Broadcast Message Transmission Method

Hereinafter, methods for transmitting and receiving broadcast messages using the BA A-MAP IEs described in Table 2 to Table 6 will be disclosed.

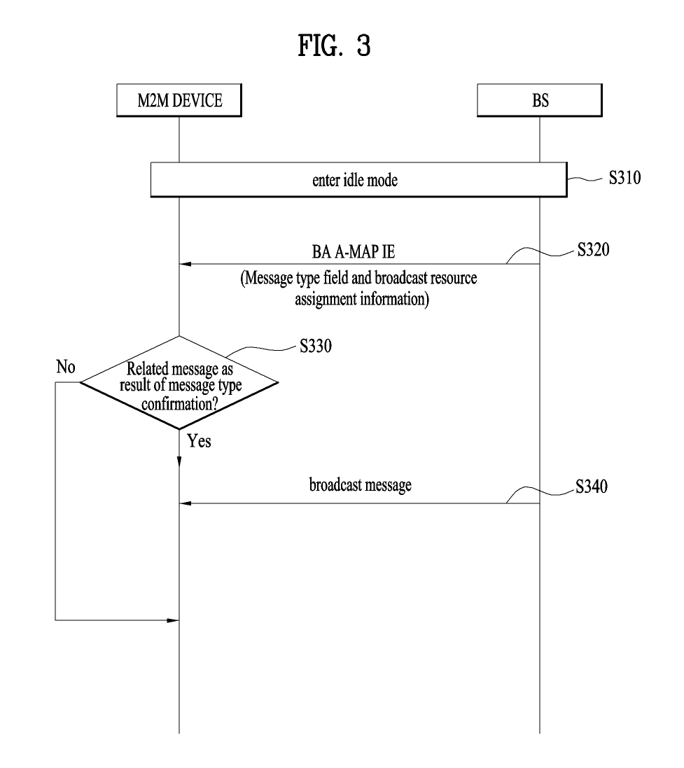

FIG. 3 is a diagram illustrating an exemplary broadcast message transmission method for idle-mode M2M devices according to an embodiment of the present invention.

In FIG. 3, an M2M device and a BS may enter idle mode by implementing the processes described in section 2 and FIG. 2 (S310).

Next, the idle-mode M2M device may receive, in a paging listening interval, a BA A-MAP IE including a message type field indicating the type of a broadcast message and broadcast resource assignment information indicating an assignment region of a broadcast burst through which the broadcast message is transmitted (S320).

In step S320, the BA A-MAP IE may use one of the BA A-MAP IEs described in Table 2 to Table 6. Although it is assumed in FIG. 3 that the BA A-MAP IE is transmitted after the M2M device enters the idle mode, the BA A-MAP IE may be transmitted from the BS prior to entering the idle mode.

The M2M device may determine whether a broadcast MAC control message necessary therefor is transmitted through the broadcast resource assignment information included in the BA A-MAP IE by confirming a message type index field or a message type bitmap field included in the BA A-MAP IE. As an example of the broadcast MAC control message needed by the M2M device, reference may be made to section 3.(1) (S330).

If the broadcast MAC control message transmitted through the broadcast resource assignment information is a message necessary for the M2M device in step S330, the M2M device receives a broadcast message by decoding the broadcast burst (i.e. resource assignment region) indicated by the broadcast resource assignment information (S340).

If the broadcast MAC control message transmitted through the broadcast resource assignment information by the M2M device is a message unnecessary for the M2M device in step S330, the M2M device may perform an idle mode operation (e.g. reentry to an unavailable interval) again without decoding the broadcast burst indicated by the broadcast resource assignment information. Through these processes, the M2M device may selectively receive only desired broadcast messages without decoding all broadcast bursts.

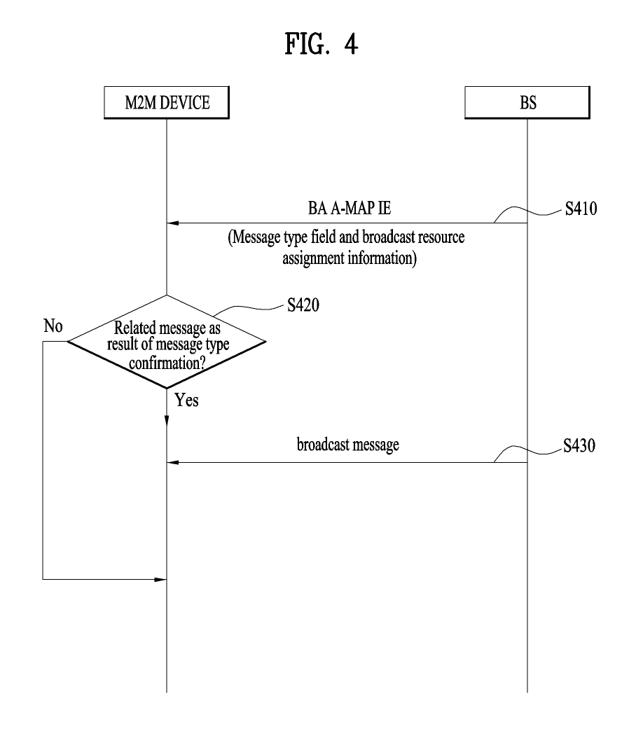

FIG. 4 is a diagram illustrating an exemplary broadcast message transmission method for connected-mode M2M devices according to an embodiment of the present invention.

In FIG. 4, the M2M device and the BS are in a normal connected-mode state. The M2M device may receive a BA A-MAP IE broadcast from the BS. In this case, the BA A-MAP IE includes a message type field indicating the type of a broadcast message and broadcast resource assignment information indicating an assignment region of a broadcast burst through which the broadcast message is transmitted and may use one of the BA A-MAP IEs described in Table 2 to Table 6 (S410).

The M2M device may determine whether a broadcast MAC control message necessary therefor is transmitted through the broadcast resource assignment information included in the BA A-MAP IE by confirming a message type index field or a message type bitmap field included in the BA A-MAP IE. As an example of the broadcast MAC control message needed by the M2M device, reference may be made to section 3.(1) (S420).

If the broadcast MAC control message transmitted through the broadcast resource assignment information is a message necessary for the M2M device in step S420, the M2M device receives a broadcast message by decoding the broadcast burst (i.e. resource assignment region) indicated by the broadcast resource assignment information (S430).

If the broadcast MAC control message transmitted through the broadcast resource assignment information is a message unnecessary for the M2M device in step S430, the M2M device may perform an idle mode operation (e.g. reentry to an unavailable interval) again without decoding the broadcast burst indicated by the broadcast resource assignment information. Through these processes, the M2M device may selectively receive only desired broadcast messages without decoding all broadcast bursts.

The present invention may be carried out in other specific ways than those set forth herein without departing from the spirit and essential characteristics of the present invention. The above embodiments are therefore to be construed in all aspects as illustrative and not restrictive. The scope of the invention should be determined by the appended claims and their legal equivalents and all changes coming within the meaning and equivalency range of the appended claims are intended to be embraced therein. Claims which are not explicitly dependent on each other may be combined to provide the embodiments or new claims may be added through amendment after this application is filed.

### INDUSTRIAL APPLICABILITY

The embodiments of the present invention may be applied to a variety of wireless access systems. Examples of the wireless access systems include a 3rd Generation Partnership Project (3GPP) system, a 3GPP2 system, and/or an Institute of Electrical and Electronic Engineers (IEEE) 802 system. The embodiments of the present invention may be applied not only to the various wireless access systems but also to all technical fields to which the various wireless access systems are applicable.

1. A method for receiving a broadcast message by a machine-to-machine (M2M) device in a wireless access system supporting an M2M environment, the method comprising:
receiving a broadcast assignment MAP information element including a message type field indicating a type of the broadcast message and a resource assignment information indicating an assignment region of a broadcast burst through which the broadcast message is transmitted; and
confirming the type of the broadcast message indicated by the message type field,
wherein, the M2M device receives the broadcast message through the broadcast burst indicated by the resource assignment information, when the type of the broadcast message is associated with the M2M device, and
the M2M device does not decode the broadcast burst indicated by the resource assignment information, when the type of the broadcast message is not associated with the M2M device.

2. The method according to claim 1, wherein the message type field indicates the type of the broadcast message in an index format or a bitmap format.

3. The method according to claim 2, wherein the broadcast assignment MAP information element further includes a mode indicator indicating whether the message type field is the index format or the bitmap format.

4. The method according to claim 2, wherein the M2M device is an idle mode state.

5. A method for broadcasting a broadcast message by a base station in a wireless access system supporting a machine-to-machine (M2M) environment, the method comprising:
broadcasting a broadcast assignment MAP information element including a message type field indicating a type of the broadcast message and a resource assignment information indicating an assignment region of a broadcast burst through which the broadcast message is transmitted; and
broadcasting the broadcast message through the broadcast burst indicated by the resource assignment information.

6. The method according to claim 5, wherein the message type field indicates the type of the broadcast message in an index format or a bitmap format.

7. The method according to claim 6, wherein the broadcast assignment MAP information element further includes a mode indicator indicating whether the message type field is the index format or the bitmap format.

8. A machine-to-machine (M2M) device for receiving a broadcast message in a wireless access system supporting an M2M environment, the M2M device comprising:
a reception module; and
a processor for supporting reception of the broadcast message,
wherein the M2M device,
receives, using the reception module, a broadcast assignment MAP information element including a message type field indicating a type of the broadcast message and a resource assignment information indicating an assignment region of a broadcast burst through which the broadcast message is transmitted,
confirms, using the processor, the type of the broadcast message indicated by the message type field,
receives the broadcast message through the broadcast burst indicated by the resource assignment information, when the type of the broadcast message is associated with the M2M device, and
does not decode the broadcast burst indicated by the resource assignment information, when the type of the broadcast message is not associated with the M2M device.

9. The method according to claim 8, wherein the message type field indicates the type of the broadcast message in an index format or a bitmap format.

10. The method according to claim 9, wherein the broadcast assignment MAP information element further includes a mode indicator indicating whether the message type field is the index format or the bitmap format.

11. The method according to claim 9, wherein the M2M device is an idle mode state.

12. A base station for broadcasting a broadcast message in a wireless access system supporting a machine-to-machine (M2M) environment, the base station comprising:
a transmission module; and
a processor for supporting broadcast of the broadcast message;
wherein the base station,
broadcasts, using the transmission module, a broadcast assignment MAP information element including a message type field indicating a type of the broadcast message and a resource assignment information indicating an assignment region of a broadcast burst through which the broadcast message is transmitted; and
broadcasts, using the transmission module, the broadcast message through the broadcast burst indicated by the resource assignment information.

13. The base station according to claim 12, wherein the message type field indicates the type of the broadcast message in an index format or a bitmap format.

14. The base station according to claim 13, wherein the broadcast assignment MAP information element further includes a mode indicator indicating whether the message type field is the index format or the bitmap format.
